(19) United States
(12) Patent Application Publication
(10) Pub. No.: US 2016/0189090 A1
(43) Pub. Date: Jun. 30, 2016

(54) Smart Scheduling for Processing Back Orders

(71) Applicants: Shamik Chakraborty, San Jose, CA (US); Suresh Ranganathan, Garnet Valley, PA (US)

(72) Inventors: Shamik Chakraborty, San Jose, CA (US); Suresh Ranganathan, Garnet Valley, PA (US)

(21) Appl. No.: 14/586,065

(22) Filed: Dec. 30, 2014

(51) Int. Cl. G06Q 10/08; G06Q 30/06

(52) U.S. Cl. CPC G06Q 10/087; G06Q 30/0635

(57) ABSTRACT

Techniques are described for scheduling open orders. Open orders can include back orders and new sales orders. The techniques can reallocate confirmed stock (e.g., stock that is in inventory but been assigned to an existing order) and unconfirmed stock (e.g., stock that is in inventory but has not been assigned to an existing order). An order typically consists of multiple line items where each line item is a request for a quantity of an item of interest. Each line item within an order can be fulfilled when inventory is allocated to the order. In some embodiments, the stock can be allocated to back orders based on a priority that has been assigned to each order. This allows orders of high priority to be processed before orders of low priority. In other embodiments, the techniques can parallel process the allocation of inventory to improve system performance.

### BACKGROUND

Many corporations today sell consumer goods to customers. Consumer goods can be a wide range of products that include electronic devices, food, beverages, cleaning agents and personal care products. Some products may sell better than others, thus creating a scenario where demand is greater than supply. This can create a backlog in open sales orders that need to be filled. When a sales order cannot be fulfilled by the customer's requested delivery date, it is considered a back order. Back orders can be fulfilled subsequently when stock becomes available. Over time, the rising offset between demand and supply can create a significant pool of back orders. As new inventory becomes available, it can be difficult to prioritize the handling of the backlog of back orders and new sales orders.

### SUMMARY

In one embodiment, a computer-implemented method receives, by a processor, a backlog containing a plurality of open sales orders, wherein each sales order includes a line item requesting delivery for a quantity of an item of interest, a customer priority value, and a requested delivery date for the item of interest, groups, by the processor, line items within the plurality of open sales orders into a plurality of camps according to the requested delivery date and the customer priority value of the line item, prioritizes, by the processor, the plurality of camps into an ordered list of camps, and saves, by the processor, the ordered list of camps in a data repository.

In one example, the plurality of camps are prioritized according to the customer priority value followed by the requested delivery date.

In another example, the plurality of camps are prioritized according to the requested delivery date followed by customer priority value.

In another example, the plurality of camps are prioritized according to the customer priority value followed by the requested delivery date for a first time period and prioritized according to the requested delivery date followed by the customer priority value for a second time period.

In another example, the method further comprises prioritizing, by the processor, the line items within each camp, wherein the line items within a camp are prioritized according to the quantity of interest corresponding to the line items.

In another example, the method further comprises selecting, by the processor, a camp from the ordered list of camps within the data repository, determining, by the processor, an available inventory of the item of interest, and launching, by the processor, a plurality of parallel jobs to allocate the available inventory to line items within the camp, wherein the available inventory is allocated based on a priority associated with the line items within the camp. In one instance, a job to allocate the inventory to a line item generates a new line item containing a difference between the quantity of the item of interest corresponding to the line item and the inventory available when the inventory available less than the quality of the item of interest corresponding to the line item.

In another embodiment, a non-transitory computer readable storage medium stores one or more programs comprising instructions for receiving a landscape model describing changes to a customer landscape, the customer landscape including a plurality of customer-side systems, automatically identifying a customer-side system within the customer landscape to upgrade based on the landscape model, identifying a server-side system within a server landscape that is associated with the customer-side system, and scheduling the customer-side system and the server-side system for upgrade.

In another embodiment, a computer implemented system comprises one or more computer processors and a non-transitory computer-readable storage medium. The non-transitory computer-readable storage medium comprises instructions, that when executed, control the one or more computer processors to be configured for receiving a landscape model describing changes to a customer landscape, the customer landscape including a plurality of customer-side systems, automatically identifying a customer-side system within the customer landscape to upgrade based on the landscape model, identifying a server-side system within a server landscape that is associated with the customer-side system, and scheduling the customer-side system and the server-side system for upgrade.

The following detailed description and accompanying drawings provide a better understanding of the nature and advantages of the present disclosure.

### BRIEF DESCRIPTION OF THE DRAWINGS

FIG. 1 illustrates a system for processing open orders according to one embodiment;

FIG. 2 illustrates a detailed system for processing open orders according to one embodiment;

FIG. 3 illustrates an example of grouping orders according to one embodiment;

FIG. 4 illustrates a processing allocating available stock to open orders according to one embodiment;

FIG. 5 illustrates an execution process according to one embodiment;

FIG. 6 illustrates an execution process according to one embodiment; and

FIG. 7 illustrates an exemplary computer system according to one embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

Described herein are techniques for scheduling open sales orders. Open sales orders can include back orders and new sales orders. The techniques can reallocate confirmed stock (e.g., stock that is in inventory but been assigned to an existing order) and unconfirmed stock (e.g., stock that is in inventory but has not been assigned to an existing order). An order typically consists of multiple line items where each line item is a request for a quantity of an item of interest. Each line item within an order can be fulfilled when inventory is allocated to the order. In some embodiments, the stock can be allocated to back orders based on a priority that has been assigned to each order. This allows orders of high priority to be processed before orders of low priority. In other embodiments, the techniques can parallel process the allocation of inventory to improve system performance.

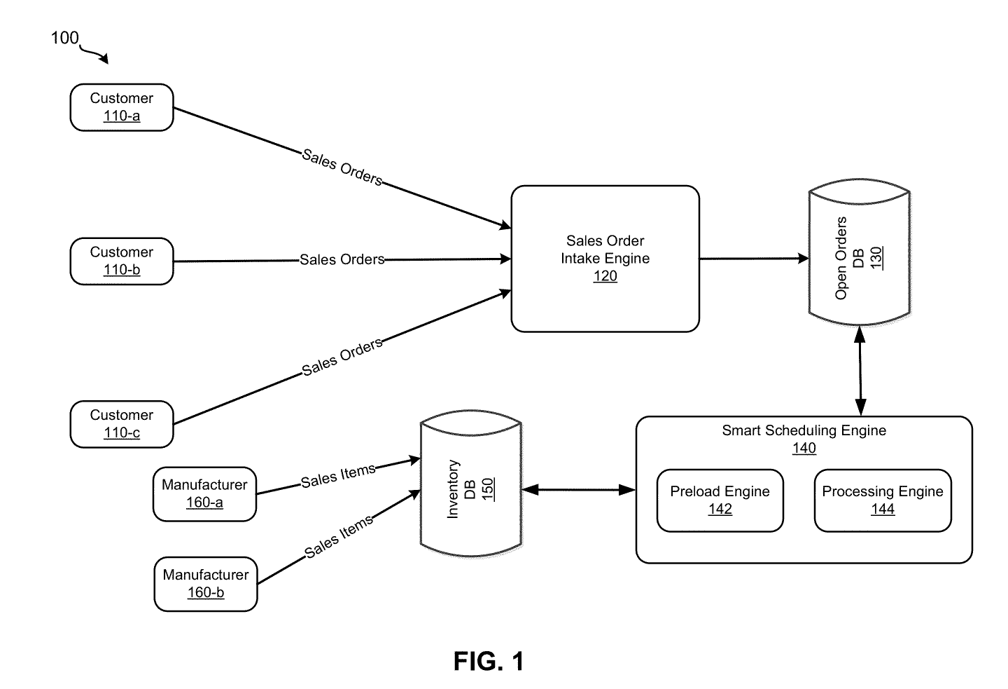

FIG. 1 illustrates a system for processing open orders according to one embodiment. System 100 includes sales order intake engine 120. Sales order intake engine 120 is configured to receive sales orders from customers 110. Here, customers 110-a, 110-b, and 110-c can place sales orders for items of interest. The sales orders are transmitted to sales order intake engine 120 for processing. Sales order intake engine 120 can process received sales orders and store them within open orders database 130. Open orders database 130 can include back orders (e.g., open orders which are already past the requested delivery date) plus sales orders (e.g., open orders which have not passed the requested delivery date). In some embodiments, sales orders and back orders can be processed together by smart scheduling engine 140.

System 100 further includes inventory database 150. Inventory database 150 can be configured to receive notifications from manufacturers 160-a and 160-b that new items are available for allocation to open orders. As sales items become available, manufacturer 160 can update inventory database 150.

System 100 further includes smart scheduling engine 140. Smart scheduling engine 140 is configured to detect when new inventory is available within inventory database 150. When new inventory is available, smart scheduling engine 140 can allocate the inventory to open orders within open orders database 130. In one embodiment, smart scheduling engine 140 can include preload engine 142 and processing engine 144. Preload engine 142 can be configured to preprocess the orders by deriving multiple camps to store line items within the orders. In one embodiment, preload engine 143 can query sales orders database 130 for line items within sales orders that are for a product of interest. Once the line items are queried, they can be assigned to camps. Each camp can group the line items according to one or more parameters. In some examples, the line items can be grouped into camps based on the customer priority and delivery date. In other examples, other criteria can be used to group the line items. Preload engine 142 can store the camps within a data repository for subsequent processing by processing engine 144.

Processing engine 144 can be configured to process the line items by allocating inventory to each line item. In one embodiment, processing engine 144 can determine the available inventory within inventory database 150 and allocate the available inventory to fulfill line items within the camps. In some embodiments, the camps can be prioritized by the preload engine 142. As a result, processing engine 144 can allocate the available inventory to high priority camps before low priority camps. In some examples, preload engine 142 can assign each camp a camp identifier which can be used to uniquely identify the camp and to also specify the priority of the camp. Similar to the camp identifier, preload engine 142 can also assign a camp sequence number to each line item within a camp to prioritize the line items within a camp. During processing, processing engine 144 can prioritize the processing of line items within a camp based on the camp sequence number associated with the line items.

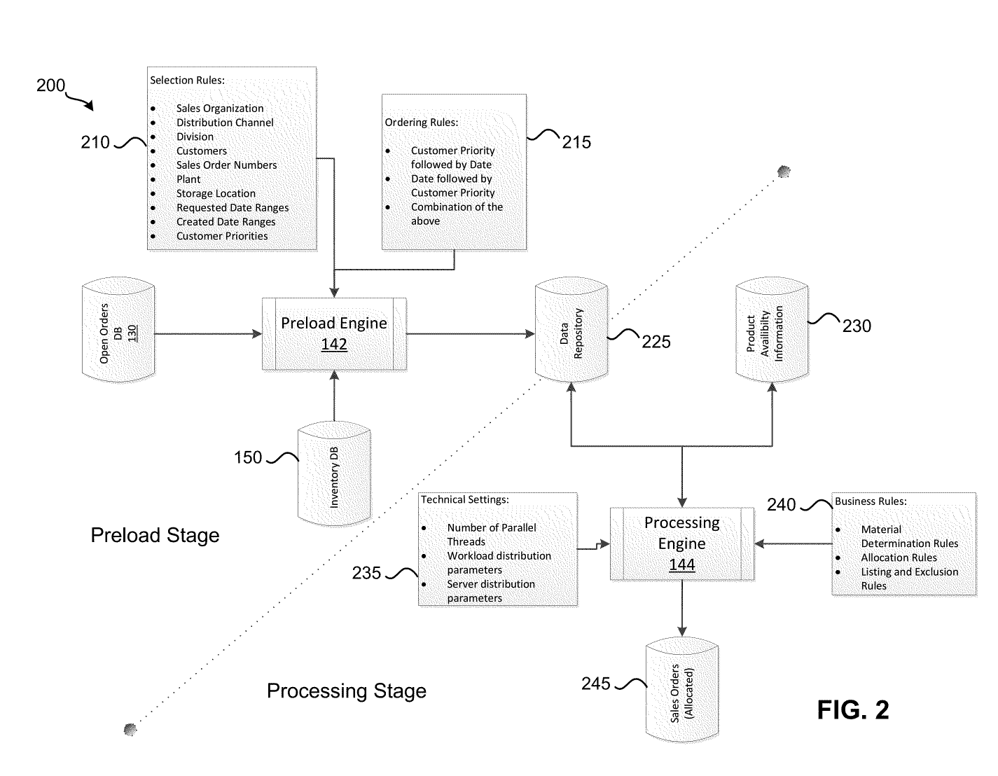

FIG. 2 illustrates a detailed system for processing open orders according to one embodiment. System 200 consists of two stages; a preload stage and a processing stage. System 200 includes preload engine 142 which is configured to perform the preload stage and processing engine 144 which is configured to perform the processing stage. In one embodiment, system 200 can process open orders on a predefined schedule. For example, open orders can be processed at 8 am every workday. In another embodiment, system 200 can monitor the inventory of stock. When the movement of stock resulting in newly available stock is detected, system 200 can process open orders to utilize the available stock.

In one embodiment, preload engine 142 can monitor inventory database 150 for the stock of items of interest. When items of interest become available, preload engine 142 can retrieve open orders from open orders database 130. The open orders can include backorders and sales orders that have yet to be fulfilled. Preload engine 142 can select open orders or line items from the open orders to fulfill with the available stock. In one embodiment, preload engine 142 can apply one or more rules from selection rules 210 to select open orders or line items from the open orders. Selection rules 210 can include various selection criteria, including sales organization, distribution channel, division, customers, sales order numbers, plant, storage location, requested date ranges, created date ranges, and customer priorities. Once orders or line items have been selected, preload engine 142 can group the selections into camps. Preload engine 142 can also optionally prioritize the camps based on ordering rules 215. Ordering rules 215 can include one or more predefined rules that specify the priority for handling camps. Exemplary rules include ordering by customer priority date, requested delivery date, a combination of the two, and other criteria provided in selection rules 210. In some embodiments, line items within the camps can also be prioritized. Prioritizing the line items within a camp allows particular line items to be fulfilled before others line items. This is advantageous when the inventory available is insufficient to fulfill all line items within a given camp. Once preload engine 142 has grouped the line items into a plurality of camps, the plurality of camps can be stored within data repository 225.

Processing engine 144 is configured to allocate available inventory to line items based on the information within data repository 225. Processing engine 144 can receive data repository 225 and product availability information 230 (which describes the available stock that can be used to fulfill open orders). Processing engine 144 can assign the available stock to line items within data repository 225 to generate allocated sales orders 245. In one embodiment, processing engine 144 can allocate available stock according to business rules 240. Business rules 240 can specify parameters to follow when allocating available stock. The parameters can include the material, determination rules, allocation rules, and listing and exclusion rules. In one embodiment, processing engine 144 can process the open orders based on technical settings 235. Technical settings 235 can specify parameters such as the maximum number of parallel threads, workload distribution parameters, and server distribution parameters. Once allocated sales orders 245 have been generated, process engine 144 can update data repository 225 on the progress. For example, process engine 144 can update data repository 225 so that allocated sales orders are marked as being processed. Similarly, process engine 144 can update product availability information 230 so that stock which has been allocated can be removed from the available inventory.

In some embodiments, preload engine 142 or processing engine 144 can be configured to perform the task of unallocating stock that is currently in a confirmed state in one or more open orders. When orders are placed, some systems can confirm available stock for an open order as the order is placed. Preload engine 142 or processing engine 144 can unallocated the stock in order to generate an accurate view of the inventory that is available for allocation during the processing stage.

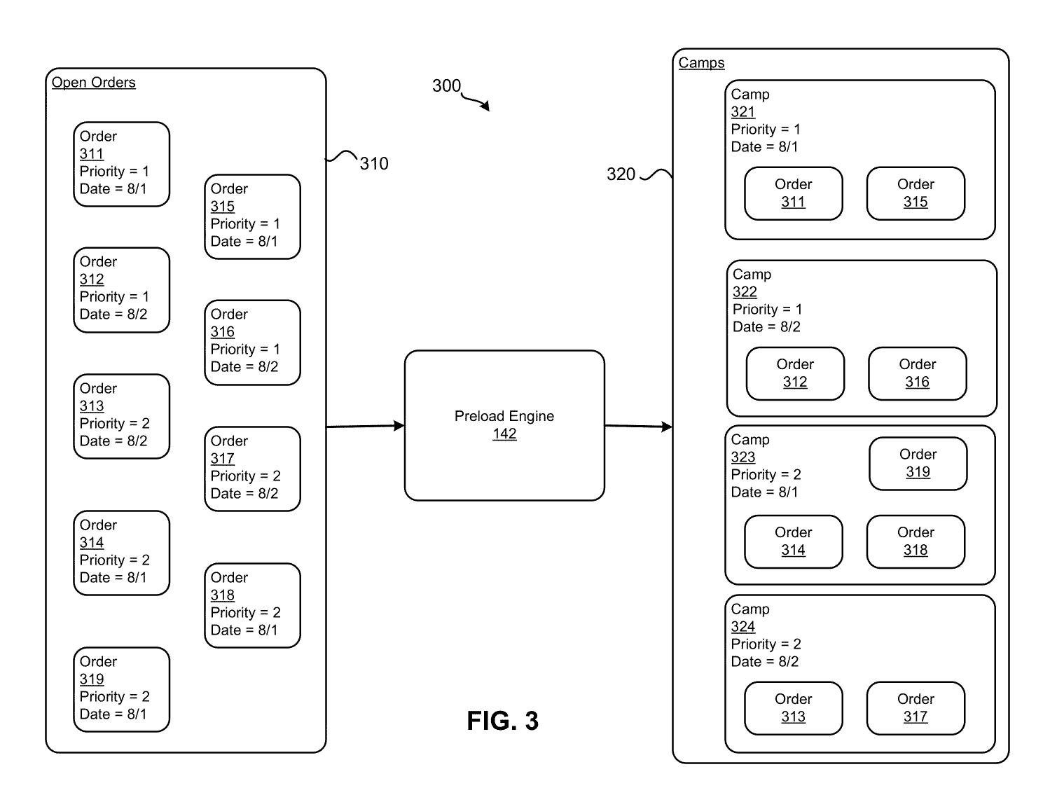

FIG. 3 illustrates an example of grouping orders according to one embodiment. As shown, system 300 includes open orders 310. Open orders 310 include orders 311-319. In this example, each open order contains a line item for an item of interest however in other examples, each open order can contain multiple line items. Each open order can include variables such as the item of interest, the number of items ordered, the customer priority (which specifies the priority given to the customer when allocating available stock), and the requested delivery date, among others. Preload engine 142 can process open orders 310 and group the sales orders based on customer priority and requested delivery date. As shown here, camps 320 includes camps 321-324. Each camp includes open orders which have the same customer priority and requested deliver date. For example, camp 321 includes order 311 and order 315 since order 311 and order 315 both have a customer priority of 1 and a requested delivery date of August 1. In other embodiments, preload engine 142 can group the orders within a range of requested delivery dates to the same camp. For example, preload engine 142 may group open orders 310 into only two camps if the camp can contain orders for a requested delivery date between August 1 and August 2. The two camps would be differentiated by the customer priority. Advantages to consolidating into fewer camps is potentially improved performance due to more orders being parallel processed by the processing engine. These details are described below.

In one embodiment, preload engine 142 can prioritize camps 310. Preload engine 142 can assign each camp a camp identifier. The camp identifier can be configured to provide a hierarchy between the camps and to also provide a unique identifier for the camps. Preload engine 142 can prioritize the camps according to ordering rules 215 being applied. In one example, ordering rules 215 can specify that the priority should assigned based on customer priority followed by the requested delivery date. Thus, the ordering of camps 320 would be camp 321, followed by camp 322, followed by camp 323, followed by camp 324. In another example, ordering rules 215 can specify that the priority should be assigned based on requested delivery date followed by the customer priority. Thus, the ordering of camps 320 would be camp 321, followed by camp 323, followed by camp 322, followed by camp 324. In another embodiment, ordering rules 215 can specify a hybrid rule. In one example, the hybrid rule can specify that priority should be assigned by customer priority followed by requested delivery date for orders within a one month window (or other predefined time period) and be assigned by requested delivery date followed by customer priority for open orders that lie outside the one month window. This can allow backorders having an old requested delivery date but low customer priority to have an increased likelihood of being processed. In another example, the hybrid rule can specify that priority should be assigned by request delivery date followed by customer priority for orders within a one month window (or other predefined period) and be assigned by customer priority followed by requested delivery date for open orders that lie outside the one month window.

In another embodiment, preload engine 142 can prioritize orders within a camp. Preload engine 142 can assign a camp sequence number to each order within the camp. The camp sequence number can signify the priority of the order within the camp. In one example, preload engine 142 can prioritize orders within a camp based on attributes such as the requested delivery rate or the customer priority when the camp includes a multiple requested delivery dates or customer priorities. In other examples, preload engine 142 can prioritize orders within a camp based on the number of items of interest that are being requested. Orders for a greater number of items can be fulfilled before orders for fewer items to decrease the likelihood that an order is only partially fulfilled.

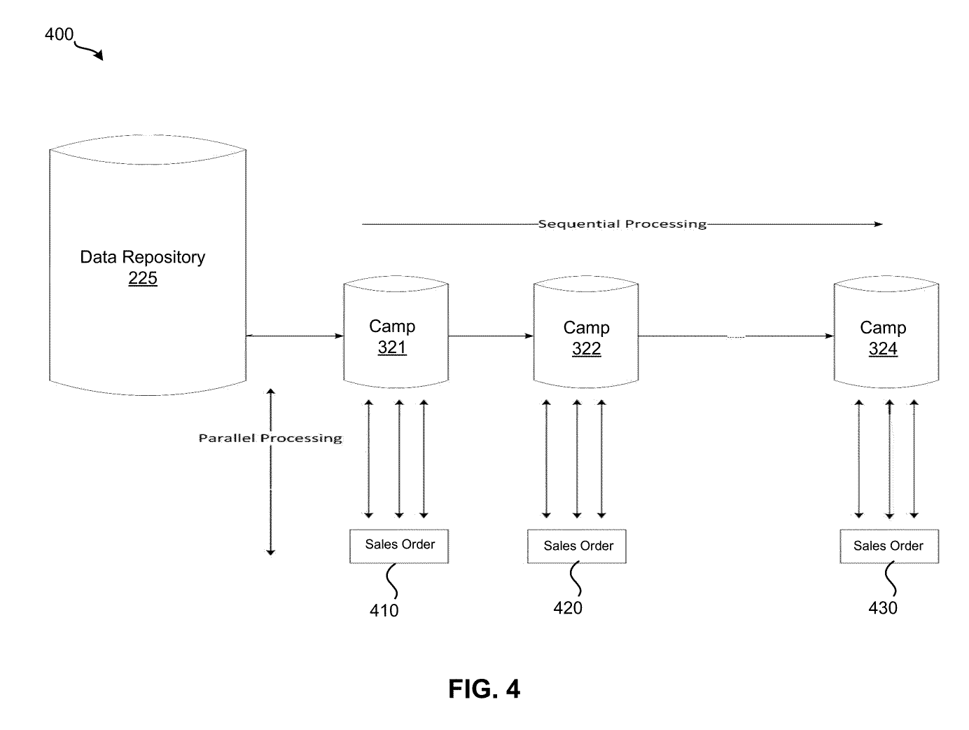

FIG. 4 illustrates a processing allocating available stock to open orders according to one embodiment. As shown here, processing engine 400 includes data repository 225. As described above, data repository 225 stores a plurality of camps. As described in FIG. 3, each camp can contain one or more orders. The one or more orders can share one or more attributes. For example, the orders can have the same customer priority and/or the same requested delivery date. In some embodiments, the orders can be sorted based on a camp sequential number which was assigned to each order by the preload engine 142.

Processing engine 400 can retrieve the camps for processing from data repository 225. In one embodiment, processing engine 400 can retrieve camps from data repository 225 in a sequential manner and process orders within each camp in parallel. As shown here, camp 321 can be retrieved from data repository 225. Processing engine 400 can launch a plurality of jobs in parallel to handle the orders within camp 321. In one embodiment, each order within camp 321 can be assigned a job. The jobs can all be executed at substantially the same time. When all jobs have completed execution, processing engine 400 can move to the subsequent camp for processing. In one embodiment, processing engine 400 can allocate available inventory to jobs based on the camp sequential number that corresponds to the order. In some instances, the available inventory can be insufficient to fulfill all the orders within a camp. When processing engine 400 detects that an open order cannot be fulfilled because the available inventory is less than the inventory requested, processing engine 400 can allocate the available inventory to a portion of the order. To address the unfulfilled portion, processing engine 400 can generate a new order within the camp to address the unfilled portion. The new order can be an unfulfilled order within the camp and processed at a later point in time when inventory becomes available. Here, the processing of camp 321 results in sales order 410. If inventory is still available after processing camp 321, processing engine 400 can continue to retrieve and process camp 322, which can result in the generation of sales order 420. Alternatively if there is no inventory, processing engine 400 can stop processing and note that camps 322 to 324 have not been fulfilled.

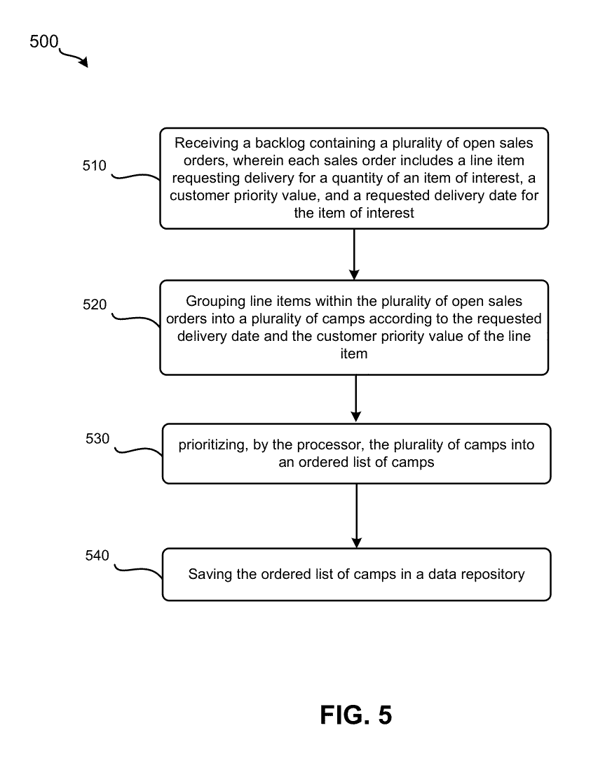

FIG. 5 illustrates an execution process according to one embodiment. Process 500 can be stored in a non-transitory computer readable medium and performed by preload engine 142. Process 500 can be initiated on a predefined interval or alternatively when it is detected that inventory is available for allocation to open orders. Process 500 begins by receiving a backlog containing a plurality of open sales orders, wherein each sales order includes a line item requesting delivery for a quantity of an item of interest, a customer priority value, and a requested delivery date for the item of interest at 510. Process 500 can process the backlog by grouping line items within the plurality of open sales orders into a plurality of camps according to the requested delivery date and the customer priority value of the line item at 520. In one embodiment, each camp can be associated with a customer priority value and a requested delivery date where line items having the customer priority value and the requested delivery date are stored within the camp. In other embodiments, each camp can be associated with more than one customer priority value or requested delivery date. This can result in larger groups and fewer camps, which can improve parallel processing when available inventory is allocated.

Process 500 then continues by prioritizing the plurality of camps into an ordered list of camps at 530. In one embodiment, the camps can be prioritized according to the requested delivery date followed by the priority date. In another embodiment, the camps can be prioritized according to the priority date followed by the requested delivery date. In yet other embodiments, a hybrid rule can be applied that combines the two described above. Process 500 then continues by saving the ordered list of camps in a data repository at 540. The data repository can be subsequently accessed when allocating the available inventory to open orders.

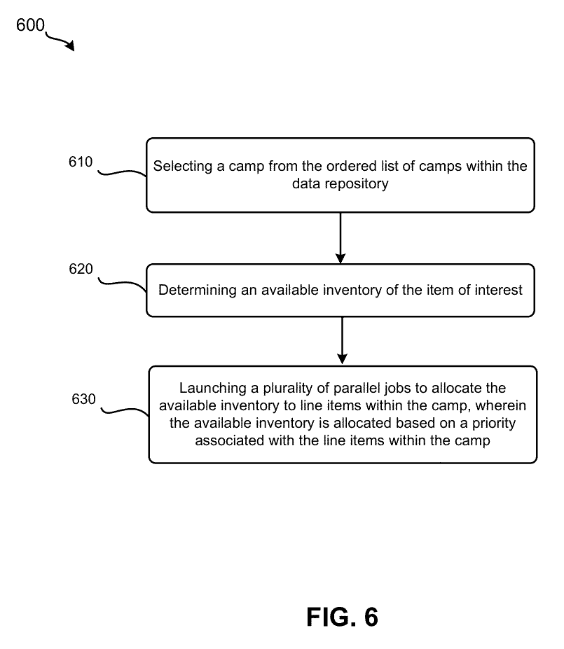

FIG. 6 illustrates an execution process according to one embodiment. Process 600 can be stored in a non-transitory computer readable medium and performed by processing engine 144. Process 600 can be initiated when preload engine 142 notifies processing engine 144 that camps have been generated. Process 600 begins by selecting a camp from the ordered list of camps within the data repository at 610. In one embodiment, the selected camp can be the camp having the highest priority. Process 600 then continues by determining an available inventory of the item of interest at 620. The item of interest can be the item which is to be allocated to the line items within the selected camp. Process 600 can then launch a plurality of parallel jobs to allocate the available inventory to line items within the camp at 630. In one embodiment, the available inventory can be allocated based on a priority associated with each line item within the camp. For example, each line item can include a camp sequence number which specifies the priority given to a particular line item.

Line items having an earlier camp sequence number can be allocated available inventory before line items having a later camp sequence number. The line items can all be processed in parallel. If a line item is processed but inventory is not available, the line item can be marked with a status of “Ignored,” which means that the line item was ignored because there was no stock to award. Other status can include “ready” (which means the line item is ready for processing), “processed” (which means the line item has already been allocated inventory), and “errors” (which means that execution ended with errors).

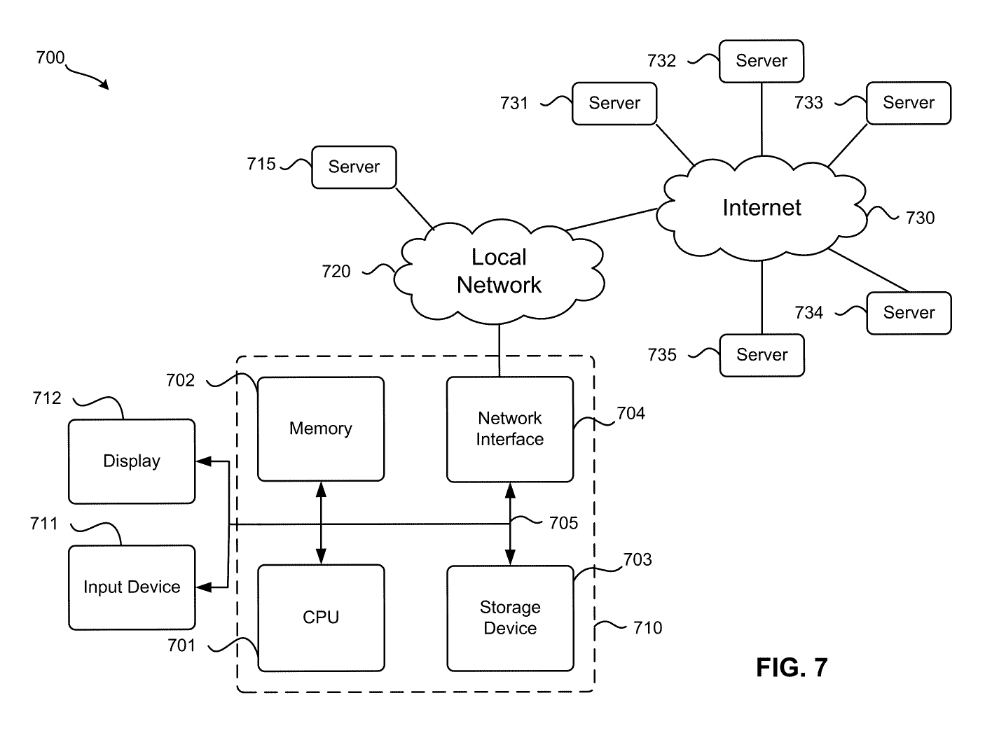

An exemplary computer system 700 is illustrated in FIG. 7. Computer system 710 includes a bus 705 or other communication mechanism for communicating information, and a processor 701 coupled with bus 705 for processing information. Computer system 710 also includes memory 702 coupled to bus 705 for storing information and instructions to be executed by processor 701, including information and instructions for performing the techniques described above, for example. This memory may also be used for storing variables or other intermediate information during execution of instructions to be executed by processor 701. Possible implementations of this memory may be, but are not limited to, random access memory (RAM), read only memory (ROM), or both. A storage device 703 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 703 may include source code, binary code, or software files for performing the techniques above, for example. Storage device and memory are both examples of computer readable mediums.

Computer system 710 may be coupled via bus 705 to a display 712, such as a cathode ray tube (CRT) or liquid crystal display (LCD), for displaying information to a computer user. An input device 711 such as a keyboard and/or mouse is coupled to bus 705 for communicating information and command selections from the user to processor 701. The combination of these components allows the user to communicate with the system. In some systems, bus 705 may be divided into multiple specialized buses.

Computer system 710 also includes a network interface 704 coupled with bus 705. Network interface 704 may provide two-way data communication between computer system 710 and the local network 720. The network interface 704 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 704 sends and receives electrical, electromagnetic, or optical signals that carry digital data streams representing various types of information.

Computer system 710 can send and receive information, including messages or other interface actions, through the network interface 704 across a local network 720, an Intranet, or the Internet 730. For a local network, computer system 710 may communicate with a plurality of other computer machines, such as server 715. Accordingly, computer system 710 and server computer systems represented by server 715 may form a cloud computing network, which may be programmed with processes described herein. In the Internet example, software components or services may reside on multiple different computer systems 710 or servers 731-735 across the network. The processes described above may be implemented on one or more servers, for example. A server 731 may transmit actions or messages from one component, through Internet 730, local network 720, and network interface 704 to a component on computer system 710. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method, comprising:
receiving, by a processor, a backlog containing a plurality of open orders, wherein each open order includes a line item requesting delivery for a quantity of an item of interest, a customer priority value, and a requested delivery date for the item of interest;
grouping, by the processor, line items within the plurality of open orders into a plurality of camps according to the requested delivery date and the customer priority value of the line item;
prioritizing, by the processor, the plurality of camps into an ordered list of camps; and
saving, by the processor, the ordered list of camps in a data repository.

2. The computer-implemented method of claim 1, wherein the plurality of camps are prioritized according to the customer priority value followed by the requested delivery date.

3. The computer-implemented method of claim 1, wherein the plurality of camps are prioritized according to the requested delivery date followed by customer priority value.

4. The computer-implemented method of claim 1, wherein the plurality of camps are prioritized according to the customer priority value followed by the requested delivery date for a first time period and prioritized according to the requested delivery date followed by the customer priority value for a second time period.

5. The computer-implemented method of claim 1, further comprising prioritizing, by the processor, the line items within each camp, wherein the line items within a camp are prioritized according to the quantity of interest corresponding to the line items.

6. The computer-implemented method of claim 1, further comprising:
selecting, by the processor, a camp from the ordered list of camps within the data repository;
determining, by the processor, an available inventory of the item of interest; and
launching, by the processor, a plurality of parallel jobs to allocate the available inventory to line items within the camp, wherein the available inventory is allocated based on a priority associated with the line items within the camp.

7. The computer-implemented method of claim 6, wherein a job to allocate the inventory to a line item generates a new line item containing a difference between the quantity of the item of interest corresponding to the line item and the inventory available when the inventory available less than the quality of the item of interest corresponding to the line item.

8. A non-transitory computer readable storage medium storing one or more programs, the one or more programs comprising instructions for:
receiving a backlog containing a plurality of open orders, wherein each open order includes a line item requesting delivery for a quantity of an item of interest, a customer priority value, and a requested delivery date for the item of interest;
grouping line items within the plurality of open orders into a plurality of camps according to the requested delivery date and the customer priority value of the line item;
prioritizing the plurality of camps into an ordered list of camps; and
saving the ordered list of camps in a data repository.

9. The non-transitory computer readable storage medium of claim 8, wherein the plurality of camps are prioritized according to the customer priority value followed by the requested delivery date.

10. The non-transitory computer readable storage medium of claim 8, wherein the plurality of camps are prioritized according to the requested delivery date followed by customer priority value.

11. The non-transitory computer readable storage medium of claim 8, wherein the plurality of camps are prioritized according to the customer priority value followed by the requested delivery date for a first time period and prioritized according to the requested delivery date followed by the customer priority value for a second time period.

12. The non-transitory computer readable storage medium of claim 8, further comprising prioritizing the line items within each camp, wherein the line items within a camp are prioritized according to the quantity of interest corresponding to the line items.

13. The non-transitory computer readable storage medium of claim 8, further comprising:
selecting a camp from the ordered list of camps within the data repository;
determining an available inventory of the item of interest; and
launching a plurality of parallel jobs to allocate the available inventory to line items within the camp, wherein the available inventory is allocated based on a priority associated with the line items within the camp.

14. The non-transitory computer readable storage medium of claim 13, wherein a job to allocate the inventory to a line item generates a new line item containing a difference between the quantity of the item of interest corresponding to the line item and the inventory available when the inventory available less than the quality of the item of interest corresponding to the line item.

15. A computer implemented system, comprising:
receiving a backlog containing a plurality of open orders, wherein each open order includes a line item requesting delivery for a quantity of an item of interest, a customer priority value, and a requested delivery date for the item of interest;
grouping line items within the plurality of open orders into a plurality of camps according to the requested delivery date and the customer priority value of the line item;
prioritizing the plurality of camps into an ordered list of camps; and
saving the ordered list of camps in a data repository.

16. The computer implemented system of claim 15, wherein the plurality of camps are prioritized according to the customer priority value followed by the requested delivery date.

17. The computer implemented system of claim 15, wherein the plurality of camps are prioritized according to the requested delivery date followed by customer priority value.

18. The computer implemented system of claim 15, wherein the plurality of camps are prioritized according to the customer priority value followed by the requested delivery date for a first time period and prioritized according to the requested delivery date followed by the customer priority value for a second time period.

19. The computer implemented system of claim 15, further comprising:
selecting a camp from the ordered list of camps within the data repository;
determining an available inventory of the item of interest; and
launching a plurality of parallel jobs to allocate the available inventory to line items within the camp, wherein the available inventory is allocated based on a priority associated with the line items within the camp.

20. The computer implemented system of claim 19, wherein a job to allocate the inventory to a line item generates a new line item containing a difference between the quantity of the item of interest corresponding to the line item and the inventory available when the inventory available less than the quality of the item of interest corresponding to the line item.
